(19) United States
(12) Patent Application Publication
(10) Pub. No.: US 2009/0302603 A1
(43) Pub. Date: Dec. 10, 2009

(54) GAS SUPPLY COUPLING FOR A WATER HEATER

(76) Inventor: Russell Clayton, Westland, MI (US)

Correspondence Address: Carlson, Gaskey & Olds/Masco Corporation, 400 West Maple Road, Suite 350, Birmingham, MI, 48009, US

(21) Appl. No.: 12/505,515

(22) Filed: Jul. 19, 2009

Related U.S. Application Data
(63) Continuation-in-part of application No. 11/282,931, filed on Nov. 18, 2005.

(51) Int. Cl. F16L 25/00

(52) U.S. Cl. 285/382

(57) ABSTRACT

A gas supply coupling includes a gas supply line receivable in a telescoped relationship with a fitting to define an interface section. A crimp ring is received at least partially over the interface section to provide a metal-to-metal seal between the fitting and the gas supply tube.

The present application is a continuation-in-part application of U.S. patent application Ser. No. 11/282,931, filed Nov. 18, 2005 and U.S. patent application Ser. No. 12/057,279, filed Mar. 27, 2009.

### BACKGROUND

The present disclosure relates to a gas supply coupling for delivering natural gas to a combustion chamber of a water heater.

Devices that utilize a combustible fuel such as propane or natural gas require connections between a multiple of components. Various connections have been provided. Although effective, current connection components are rather expensive and may require a welded connection which may complicate installation for combustible fuel devices.

### SUMMARY

A gas supply coupling according to an exemplary aspect of the present disclosure includes a gas supply line receivable in a telescoped relationship with a fitting to define an interface section. A crimp ring is received at least partially over the interface section to provide a metal-to-metal seal between the fitting and the gas supply tube.

A method of assembling a gas supply coupling for delivering combustion gases to a device according to an exemplary aspect of the present disclosure includes telescoping a gas supply line with a fitting at an interface section and connecting the gas supply tube and the fitting with a crimp ring at the interface section.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a general side view of a gas supply coupling for a water heater embodied in the present invention;

FIG. 2A is an exploded view of a fitting for the gas supply coupling;

FIG. 2B is a front view of a plate for the gas supply coupling;

FIG. 2C is a sectional side view of the fitting of FIG. 2A mounted within an opening defined in the housing of a water heater;

FIG. 3 is an exploded view of another gas supply coupling; and

FIG. 4 is a sectional view of the fitting in an crimped position.

### DETAILED DESCRIPTION

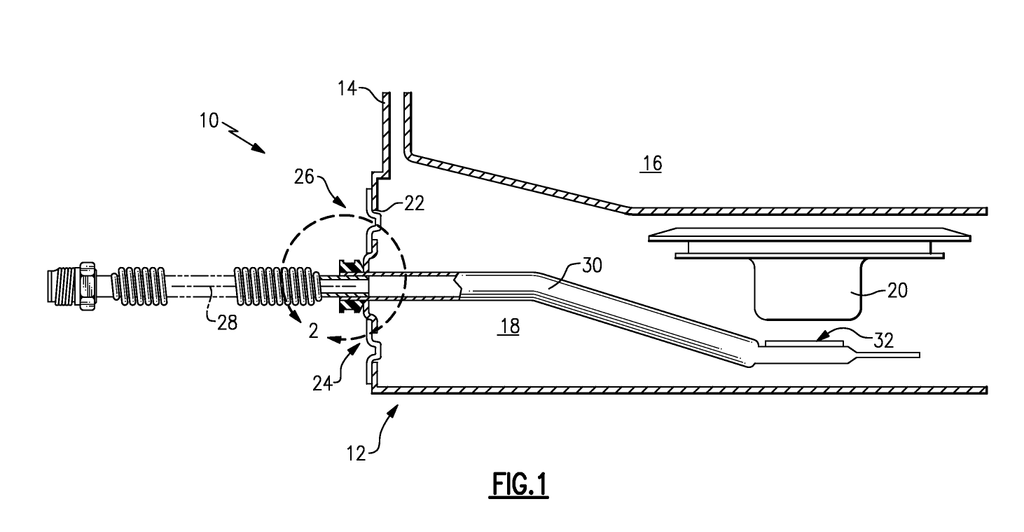

FIG. 1 illustrates a general perspective view of a gas supply assembly 10 for use with a water heater assembly 12. The water heater assembly 12 includes a water heater housing 14 that may be compartmentalized to include a water tank 16 and a combustion chamber 18. Disposed within the combustion chamber 18 is a burner 20 in close proximity to the water tank 16. The gas supply assembly 10 of the present invention is designed to deliver fuel to the burner 20 for combustion proximate the water tank 16 thereby heating the water within the tank 16 to a predetermined temperature. The gas supply assembly 10 will be connected to a fuel supply F which in the preferred embodiment is natural gas although it is contemplated that the gas supply assembly 10 may be used with other fuel types including propane. The combustion chamber 18 includes an opening 22 to the exterior of the water heater 12 to facilitate access to the gas supply and combustion elements. However, this opening 22 may also form a pathway for foreign elements and gases to reach the burner 20.

The gas supply assembly 10 is disposed within and extends through the opening 22 of the combustion chamber 18. The gas supply assembly 10 includes a bulkhead shield 24 configured to seat within the opening 22 thereby closing this pathway into the combustion chamber 18. Mounted to the shield 24 is a coupling 26 which provides interconnection between a gas supply line 28 and a gas supply tube 30. The gas supply line 28, in one non-limiting embodiment, is a flexible line which is connected to the fuel supply. The gas supply tube 30 is, in one non-limiting embodiment, a rigid tube with an outlet port 32 at the burner 20 for delivering the fuel to the burner 20.

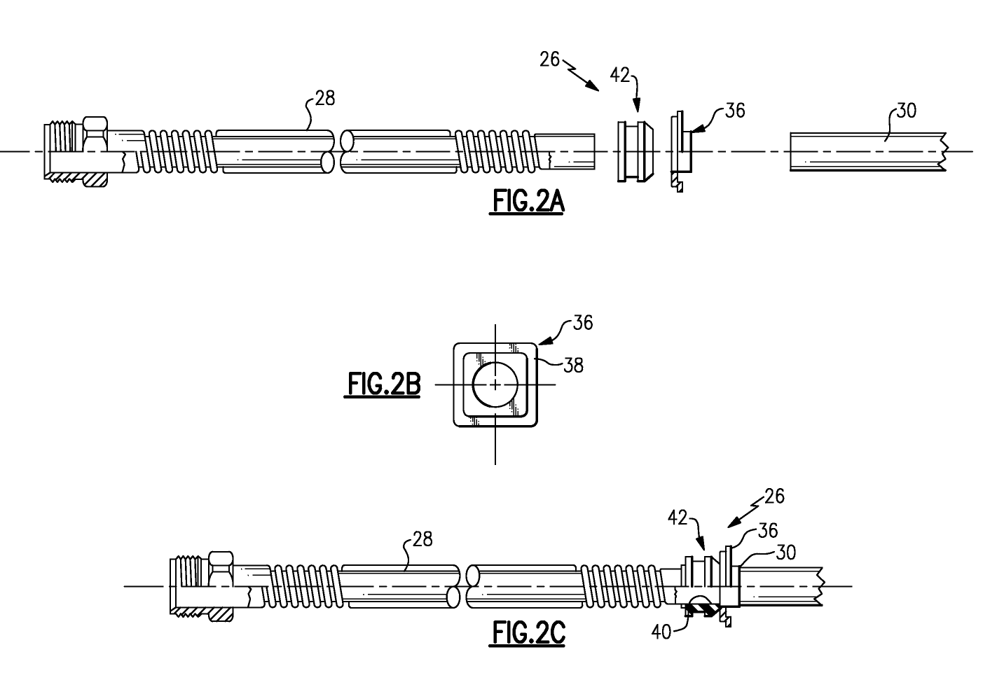

Referring to FIG. 2A, the coupling 26 includes a plate 36 having a stepped outer periphery 38 (FIG. 2B) for receipt into the shield 24 (FIG. 1). The plate 36 has a non-circular profile and is staked or welded into the shield 24 and to the gas supply tube 30, however other attachments may also be utilized.

Referring to FIG. 2C, the gas supply tube 30 receives the gas supply line 28 directly therein in an overlapped or telescoped relationship at an interface section 40. It should be understood that other male/female receipt arrangements may also be utilized.

A crimp ring 42 provides a metal-to-metal seal between the supply tube 30 and the gas supply line 28 at the interface section 40. One such crimp ring 42 may be a crimp ring manufactured by Lokring of Bartow, Fla. The crimp ring 42 includes a ramped inner diameter to provide contact stresses which are sufficiently high to plastically yield a portion of the interface section 40 between the gas supply tube 30 and the gas supply line 28 forming a circumferential, permanent, metal-to-metal seal. The crimp ring 42 facilitates a permanent joint and avoids the usage of elastomeric or rubber seals, O-rings or gaskets which may degrade and leak over time. The crimp ring 42 essentially meets all criteria of a welded connection, except that no heat is required to make the connection.

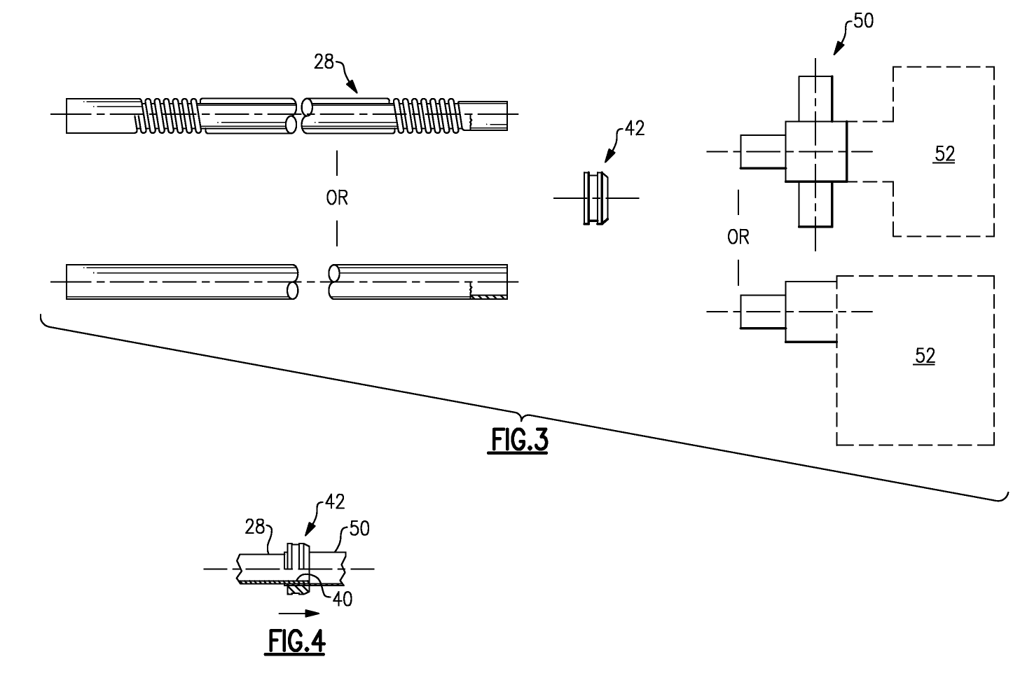

Referring to FIG. 3, another non-limiting embodiment of the coupling 26 includes the gas supply line 28, the crimp ring 42, and a fitting 50 of a device 52 (illustrated schematically). The fitting 50 may be a tee, and elbow, or any other type of fitting either connected to or forming a portion of the device 52 such as a gas range, oven, fireplace, water heater, furnace, cloths dryer, BBQ grill or any other gas or liquid propane type appliance. Alternatively, the fitting 50 may include a valve, regulator or other gas control device.

With reference to FIG. 4, in one non-limiting embodiment of a method of assembly, the crimp ring 42 is positioned over the smaller diameter of the gas supply line 28 and fitting 50. The gas supply line 28, in the disclosed, non-limiting embodiment is telescoped into the fitting 50 to provide the interface section 40. The crimp ring 42 is then slide over the fitting 50 to at least partially engage over the interface section 40 and thereby plastically yield a portion of the interface section 40 between the gas supply line 28 and the fitting 50 to form a circumferential, permanent, metal-to-metal seal.

It should be understood that although a particular component arrangement is disclosed in the illustrated embodiment, other arrangements will benefit from the instant invention.

Although particular step sequences are shown, described, and claimed, it should be understood that steps may be performed in any order, separated or combined unless otherwise indicated and will still benefit from the present invention.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A gas supply coupling comprising:
a fitting;
a gas supply line receivable in a telescoped relationship with said fitting to define an interface section; and
a crimp ring received at least partially over said interface section to provide a metal-to-metal seal between said fitting and said gas supply tube.

2. The gas supply coupling as recited in claim 1, wherein said gas supply line is receivable into said fitting.

3. The gas supply coupling as recited in claim 1, wherein said fitting is receivable into said gas supply line.

4. The gas supply coupling as recited in claim 1, wherein said gas supply tube is flexible.

5. The gas supply coupling as recited in claim 1, wherein said crimp ring includes a ramped inner surface.

6. The gas supply coupling as recited in claim 1, wherein said fitting includes a gas control device.

7. The gas supply coupling as recited in claim 6, wherein said fitting includes a valve.

8. A method of assembling a gas supply for delivering combustion gases to a device comprising:
telescoping a gas supply line with a fitting at an interface section; and
connecting the gas supply tube and the fitting with a crimp ring at the interface section.

9. A method as recited in claim 8, wherein the crimp ring provides a metal-to-metal seal.

10. A method as recited in claim 8, wherein the crimp ring provides a permanent joint between the gas supply tube and the fitting.
